(19) United States
(12) Patent Application Publication
(10) Pub. No.: US 2014/0145976 A1
(43) Pub. Date: May 29, 2014

(54) COLOR FILTER SUBSTRATE, IN-CELL OPTICAL TOUCH DISPLAY PANEL INCLUDING THE SAME AND MATERIALS OF INFRARED FILTER LAYER

(71) Applicant: CHUNGHWA PICTURE TUBES, LTD., TAOYUAN (TW)

(72) Inventors: Feng-Chin TANG, Taoyuan County (TW); Wen-Jen HSIEH, Taoyuan County (TW); Wen-Chin HUNG, Taichung City (TW); Lin-Fen CHANG, Taoyuan County (TW); Peng-Tzu CHEN, Tainan City (TW); Fu-Yen HO, Hsinchu County (TW)

(73) Assignee: CHUNGHWA PICTURE TUBES, LTD., TAOYUAN (TW)

(21) Appl. No.: 13/792,180

(22) Filed: Mar. 10, 2013

(30) Foreign Application Priority Data
Nov. 27, 2012 (TW) 101144326

(51) Int. Cl. G02B 5/20; G06F 3/042

(52) U.S. Cl. CPC G02B 5/208; G06F 3/0421
USPC 345/173

(57) ABSTRACT

A color filter substrate for an in-cell optical touch display panel is provided, which includes a substrate, a visible-light shielding structure, a color filter layer and an infrared filter layer. The visible-light shielding structure is disposed on the substrate to define sub-pixel regions and touch sensor regions of the substrate. The color filter layer covers the sub-pixel regions. The infrared filter layer covers the touch sensor regions. The infrared filter layer is made of a single infrared-light permeable material, which has a light transmittance in infrared-light wavelength range greater than a light transmittance in visible-light wavelength range. An in-cell optical touch display panel including the color filter substrate and materials of the infrared filter layer are also provided.

### RELATED APPLICATIONS

This application claims priority to Taiwan Application Serial Number 101144326, filed. Nov. 27, 2012, which is herein incorporated by reference.

### BACKGROUND

1. Technical Field

The present invention relates to a color filter substrate, and more particularly, to a color filter substrate for an in-cell optical touch display panel.

2. Description of Related Art

The touch interface enables users to easily input information and make options, such that touch display panels with the touch interface have been seen in more and more diverse applications. The touch display panel can be classified as an out-cell touch display panel and an embedded touch display panel depending on the position of the touch panel disposed in the touch display panel. The out-cell touch display panel refers to a display panel with the touch panel external disposed thereto. The embedded touch display panel, concerning the use in a liquid crystal display panel, can further be classified into an in-cell type (i.e., touch sensors disposed on a driving substrate) and an on-cell type (i.e., touch sensors disposed on a color filter substrate) depending on the position of the touch sensors. Besides, the embedded touch display panel can be classified as a resistive, a capacitive and an optical touch display panels based on the induction principles of electricity.

As to the optical touch display panel, the touch position is determined by the shadow generated by user's touch. However, a resin black matrix of the conventional color filter substrate blocks infrared-light and visible-light, and thus cannot be used as the material for the touch sensor correspondingly disposed on the driving substrate. Therefore, there is still a need for a material exhibiting high light transmittance in infrared-light wavelength range to overcome the foregoing problems.

### SUMMARY

The present invention provides a color filter substrate including an infrared filter layer, which has a light transmittance in infrared-light wavelength range greater than a light transmittance in visible-light wavelength range, applicable to an in-cell optical touch display panel.

One aspect of the present invention provides a color filter substrate for an in-cell optical touch display panel including a substrate, a visible-light shielding structure, a color filter layer and an infrared filter layer. The visible-light shielding structure is disposed on the substrate to define sub-pixel regions and touch sensor regions of the substrate. The color filter layer covers each of the sub-pixel regions. The infrared filter layer covers at least a portion of the touch sensor regions. The infrared filter layer is made of a single infrared-light permeable material, which has a light transmittance in infrared-light wavelength range greater than a light transmittance in visible-light wavelength range.

Another aspect of the present invention provides an in-cell optical touch display panel including the above-mentioned color filter substrate, a driving substrate and a display medium. The driving substrate is parallel to the color filter substrate, in which the driving substrate includes touch sensors respectively corresponding to the touch sensor regions of the color filter substrate. The display medium is interposed between the color filter substrate and the driving substrate.

Another aspect of the present invention provides an infrared-light permeable material of an infrared filter layer of a color filter substrate for an to in-cell optical touch display panel, and the infrared-light permeable material includes a photo-curable material, a photo-initiator and pigments. The pigments have a content of 40 to 80 wt %, based on the total weight of the infrared-light permeable material. The infrared-light permeable material has a light transmittance in infrared-light wavelength range greater than a light transmittance in visible-light wavelength range.

### BRIEF DESCRIPTION OF THE DRAWINGS

The invention may be more fully understood by reading the following detailed description of the embodiment, with reference made to the accompanying drawings as follows:

FIG. 1A is a top view of a color filter substrate according to one embodiment of the present invention;

FIG. 1B is a cross-sectional view of a color filter substrate according to one embodiment of the present invention;

FIG. 2A is a top view of a color filter substrate according to another embodiment of the present invention;

FIG. 2B is a cross-sectional view of a color filter substrate according to another embodiment of the present invention;

FIG. 3 is a cross-sectional view of an in-cell optical touch display panel according to one embodiment of the present invention;

FIG. 4 is a cross-sectional view of an in-cell optical touch display panel according to another embodiment of the present invention;

FIG. 5A is an infrared spectrum of a photoresist according to one embodiment of the present invention; and

FIG. 5B is an enlarged view of FIG. 5A.

### DETAILED DESCRIPTION

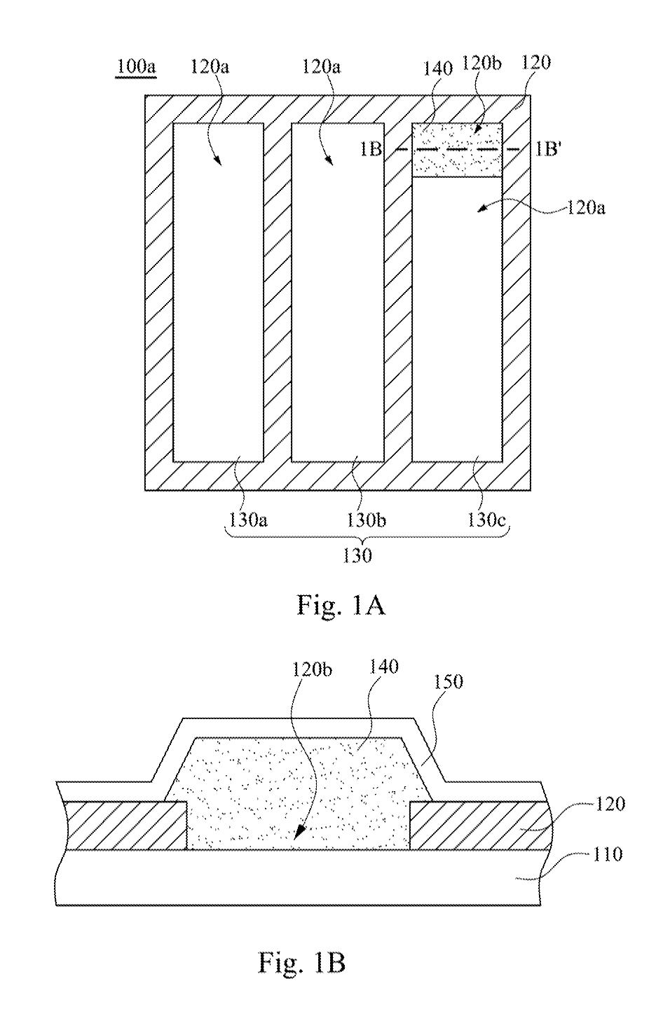

FIG. 1A is a top view of a color filter substrate 100a according to one embodiment of the present invention. FIG. 1B is a cross-sectional view along line 1B-1B′ of FIG. 1A. Please refer to FIG. 1A and FIG. 16, the color filter substrate 100a includes a substrate 110, a visible-light shielding structure 120, a color filter layer 130 and an infrared filter layer 140. In the embodiment of the present invention, the infrared filter layer 140 is made of an infrared-light permeable material having a light transmittance in infrared-light wavelength range greater than a light transmittance in visible-light wavelength range, such that it is able to be applied to a color filter substrate for an in-cell optical touch display panel.

The term “infrared-light wavelength range” herein refers to the wavelength range of 780 to 1000 nm. The term “visible-light wavelength range” herein refers to the wavelength range of 390 to 780 nm. Generally, light transmittance in visible-light and infrared-light wavelength ranges can be measured by an infrared/visible spectrometer.

The substrate 110 may be glass, quartz or a transparent, flexible plastic substrate.

The visible-light shielding structure 120 is disposed on the substrate 110 to define sub-pixel regions 120a and touch sensor regions 120b of the substrate 110, as shown in FIG. 1A. For instance, a visible-light-shielding material is formed on the substrate 110, and a photolithographic process is performed to to form the visible-light shielding structure 120 to define the sub-pixel regions 120a and the touch sensor regions 120b. The position and the size of the sub-pixel region 120a and the touch sensor region 120b are not limited thereto. Specifically, the position and the size of the sub-pixel region 120a and the touch sensor region 120b can be determined by the position of the corresponding touch sensor of the driving substrate, and also can be designed based on the amounts and the combination of the sub-pixels and the aperture ratio of each of the sub-pixels. Therefore, FIG. 1A is an illustrative diagram of one of the embodiments but not used to limit the present invention.

The color filter layer 130 covers each of the sub-pixel regions 120a. Typically, color photoresists can be processed to form the color filter layer 130 by photolithographic processes or printing processes. For instance, sub-color filter layers 130a, 130b, 130c are respectively formed from three color photoresists exhibiting different colors, as shown in FIG. 1A.

In order to allow that the corresponding touch sensor can detect the change of infrared-light, the infrared filter layer 140 is disposed on the touch sensor region 120b, as shown in FIG. 1A. The infrared filter layer 140 should have enough high light transmittance in infrared-light wavelength range and enough low light transmittance in visible-light wavelength range so as to actually applied to the color filter substrate for the in-cell optical touch display panel. Accordingly, a novel infrared-light permeable material exhibiting the above-mentioned characteristics of light transmittance is provided. The material includes a photo-curable material, a photo-initiator and pigments. The pigments have a content of 40 to 80 wt %, based on the total weight of the infrared-light permeable material.

The photo-curable material can be photopolymerized and cured by light irradiation. The photo-curable material may be an acrylic monomer, an acrylic oligomer or a mixture thereof. In one embodiment, the photo-curable material has a content of 10 to 30 wt %, based on the total weight of the infrared-light permeable material.

The acrylic monomer may be a monomer having one or more acrylic groups. For instance, the acrylic monomer may be dipentaerythritol hexamethacrylate, dipentaerythritol pentamethacrylate, pentaerythritol tetramethacrylate, trimethylol propane trimethacrylate, pentaerythritol trimethacrylate, pentaerythritol methacrylate, diallyl phthalate, tripropylene glycol dimethacrylate, neopentyl glycol dimethacrylate propylene oxide adduct, ethylene glycol methacrylate, diethylene glycol dimethacrylate, propylene glycol dimethacrylate, diethylene glycol dimethacrylate, polyethylene glycol dimethacrylate, polypropylene glycol dimethacrylate, dimethyl hexyl acrylate, neopentyl glycol dimethacrylate, glycerol dimethacrylate, glycerol trimethacrylate, glycerol tetramethacrylate, 1,4-butanediol diacrylate or a mixture thereof. In one embodiment, the acrylic monomer has a content of 4 to 15 wt %, based on the total weight of the infrared-light permeable material.

The acrylic oligomer may be polyurethane acrylate, polyester acrylate, polyether acrylate, epoxy acrylate, silicon acrylate, polyurethane methacrylate, polyester methacrylate, polyether methacrylate, epoxy methacrylate or a mixture thereof. In one embodiment, the acrylic oligomer has a content of 5 to 15 wt %, based on the total weight of the infrared-light permeable material.

The photo-initiator may be 1-hydroxycyclohexyl phenyl ketone, 2-methyl-1(4-(methylthio) phenyl)-2-morpholino-propan-1-ketone, benzyldimethyl ketone, 1-(4-dodec-phenyl)-2-hydroxy-2-methyl propan-1-ketone, 2-hydroxy-2-methyl-1-phenyl propan-1-ketone, 1-(4-isopropyl phenyl)-2-hydroxy-2-methyl propan-1-ketone, diphenyl ketone, etc. In one embodiment, the photo-initiator has a content of 2 to 10 wt %, based on the total weight of the infrared-light permeable material.

The pigments refer to chromogenic materials. In one embodiment, the pigments are selected from the group consisting of organic pigments, inorganic pigments and a combination thereof.

In one embodiment, the organic pigments are selected from the group consisting of red pigments, yellow pigments, green pigments, blue pigments, violet pigments and a combination thereof. The above-mentioned color pigments may be the compounds classified as pigments in the Color Index (issued by The Society of Dyers and Colourists Company).

The red pigments may be C.I. Pigment Red 1, C.I. Pigment Red 2, C.I. Pigment Red 3, C.I. Pigment Red 177 or C.I. Pigment Red 254.

The yellow pigments may be C.I. Pigment Yellow 1, C.I. Pigment Yellow 3, C.I. Pigment Yellow 12, C.I. Pigment Yellow 13, C.I. Pigment Yellow 83, C.I. Pigment Yellow 138, C.I. Pigment Yellow 139, C.I. Pigment Yellow 150, C.I. Pigment Yellow 180 or C.I. Pigment Yellow 185.

The green pigments may be C.I. Pigment Green 7 or C.I. Pigment Green 36.

The blue pigments may be C.I. Pigment Blue 15, C.I. Pigment Blue 15-3, C.I. Pigment Blue 15-4 or C.I. Pigment Blue 15-6.

The violet pigments may be C.I. Pigment Violet 23 or C.I. Pigment Violet 23-19.

In one embodiment, the inorganic pigments are selected from the group consisting of titanium oxide, barium sulfate, calcium carbonate, zinc white, lead sulfate, yellow lead, zinc yellow, red iron oxide (III), cadmium red, ultramarine blue, Prussian blue, chromium oxide green, cobalt green, ocher, titanium black, synthetic iron black, carbon black and a combination thereof.

In one embodiment, the pigments of the infrared-light permeable material include the red pigments, the green pigments and the blue pigments to exhibit ultra low light transmittance in visible-light wavelength range. The red pigments have a content of 25 to 40 wt % based on the total weight of the infrared-light permeable material, and the green pigments have a content of 5 to 15 wt % based on the total weight of the infrared-light permeable material, and the blue pigments have a content of 10 to 25 wt % based on the total weight of the infrared-light permeable material.

The material of the infrared filter layer 140 may further includes a stability additive, a colored dye and a solvent. The stability additive may be a surfactant such as polysiloxane, modified polysiloxane, polyether modified polysiloxane, polyester modified polysiloxane or a combination thereof. The colored dye may be nitroso dye, azo dye, nitro dye or a combination thereof. The solvent may be propylene glycol monomethyl ether or other suitable solvents. In one embodiment, the stability additive has a content of 0.2 to 1 wt %, based on the total weight of the infrared-light permeable material. In one embodiment, the colored dye has a content of 10 to 15 wt %, based on the total weight of the infrared-light permeable material. In one embodiment, the solvent has a content of 20 to 35 wt %, based on the total weight of the infrared-light permeable material.

The infrared filter layer 140 can be made from the infrared-light permeable material by a photolithographic process. In one embodiment, the formed infrared filter layer 140 has a light transmittance greater than 70% in infrared-light wavelength range of not smaller than 850 nm.

Particularly, the formed infrared filter layer 140 has ultra low light transmittance in visible-light wavelength range. In one embodiment, the infrared filter layer 140 has a light transmittance less than 5% in visible-light wavelength range of 400-780 nm, better less than 3%, still better less than 2%. In one embodiment, the infrared filter layer 140 has a light transmittance less than 1% in visible-light wavelength range of 400-700 nm, better less than 0.5%, still better less than 0.2%. In one embodiment, the infrared filter layer 140 has an optical density (OD) value greater than 4.2.

For an example, various materials used to produce the infrared filter layer are firstly mixed and dissolved. After coating, baking, exposure and development processes, the infrared filter layer with a thickness of 4.5 μm. The infrared filter layer has an OD value of about 4.9.

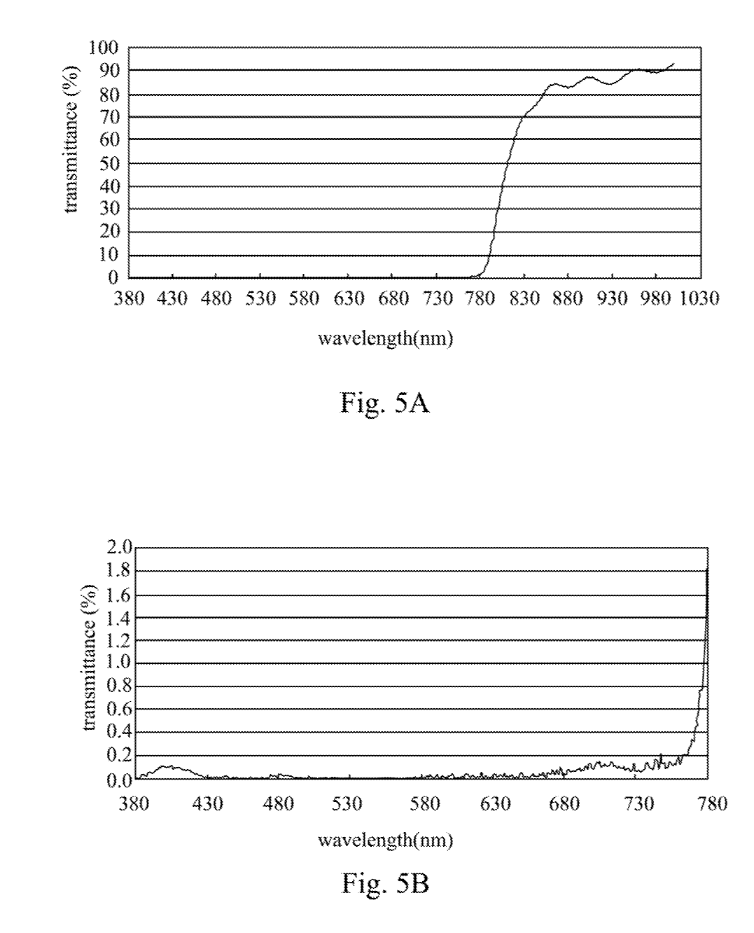

In addition, a light transmittance test of the infrared filter layer is performed. As shown in FIG. 5A and FIG. 5B, the infrared filter layer has a light transmittance greater than 78% in infrared-light wavelength range of not smaller than 850 nm. The infrared filter layer 140 has a light transmittance less than 2% in visible-light wavelength range of 400-780 nm and a light transmittance less than 0.2% in visible-light wavelength range of 400-700 nm. Accordingly, the infrared filter layer is indeed able to effectively block visible-light and allow infrared-light to penetrate, and thus can be applied to the color filter substrate for the in-cell optical touch display panel.

In one embodiment, the visible-light shielding structure 120 is made of a conventional resin black matrix (RBM) material, which is capable of effectively shielding infrared and visible-light to avoid light leakage of the panel.

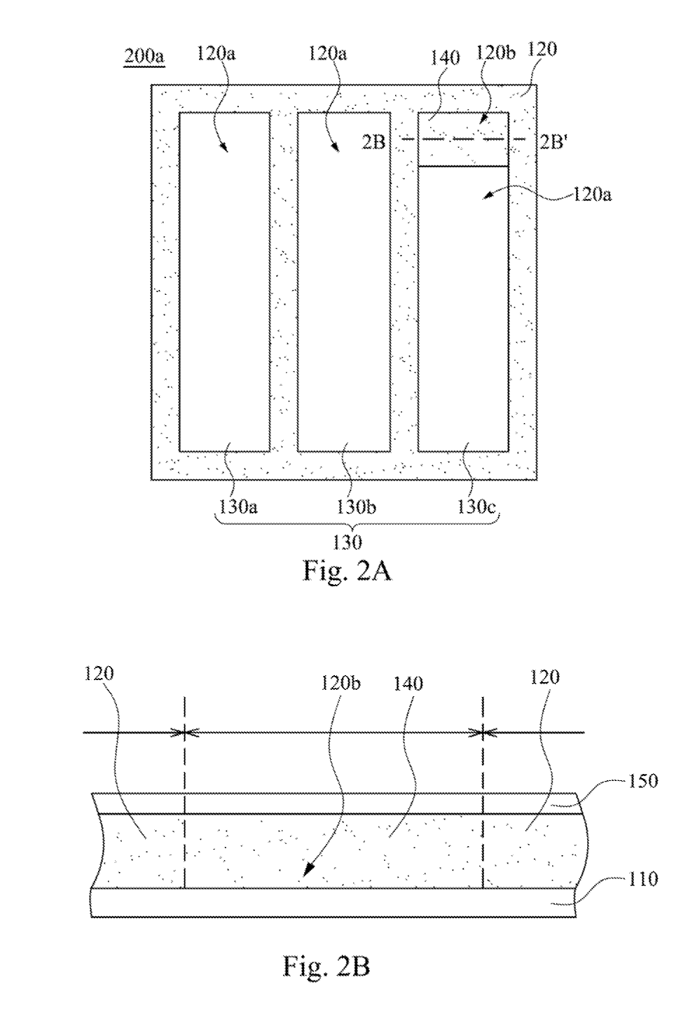

Because the infrared-light permeable material of the present invention exhibits good visible-light shielding property, thus, in one embodiment, the visible-light shielding structure 120 and the infrared filter layer 140 are made of the same material. In other words, the visible-light shielding structure 120 and the infrared filter layer 140 are formed in one process simultaneously, as shown in FIG. 2B. Compared to forming the structure of FIG. 1A, fewer steps for forming the structure of FIG. 2A are required and thus process costs can be saved.

In one embodiment, the color filter substrate 100a or 200a further includes a transparent conductive layer 150 covering the visible-light shielding structure 120, the color filter layer 130 and the infrared filter layer 140, as shown in FIG. 1B and FIG. 2B. The transparent conductive layer 150 may be made of indium tin oxide. The transparent conductive layer 150 may be formed by a physical vapor deposition method or a chemical vapor deposition method.

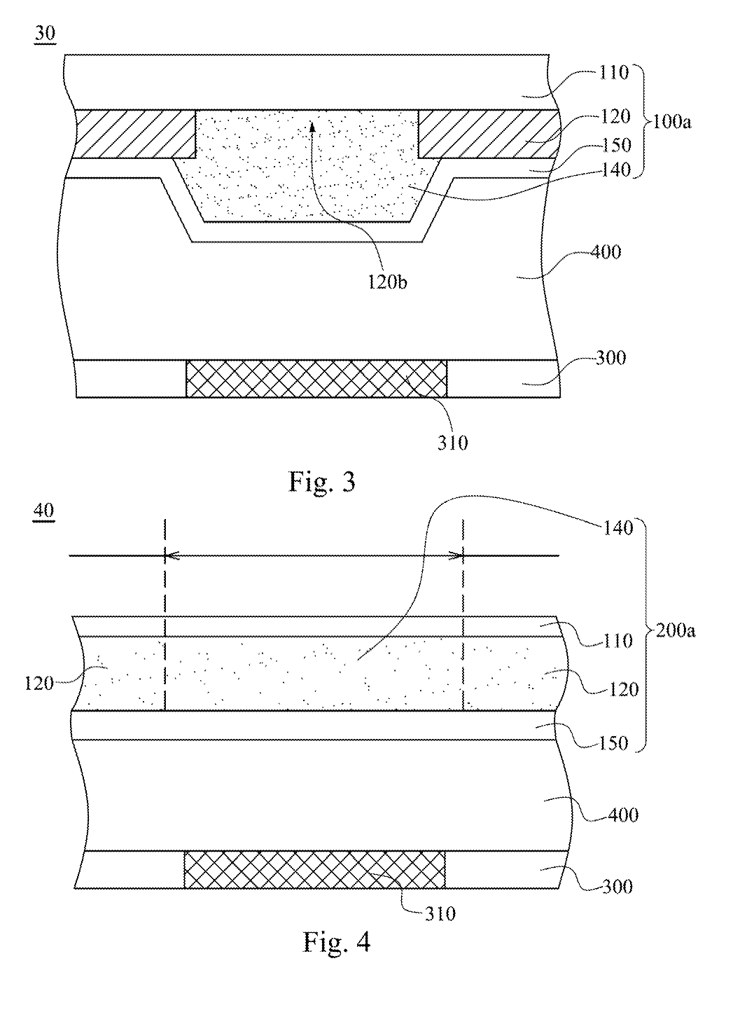

FIG. 3 is a cross-sectional view of an in-cell optical touch display panel according to one embodiment of the present invention. The in-cell optical touch display panel 30 includes the above-mentioned color filter substrate 100a, a driving substrate 300 and a display medium 400. FIG. 4 is a cross-sectional view of an in-cell optical touch display panel according to another embodiment of the present invention. The in-cell optical touch display panel 40 includes the above-mentioned color filter substrate 200a, a driving substrate 300 and a display medium 400.

As shown in FIG. 3, the driving substrate 300 is parallel to the color filter substrate 100a, in which the driving substrate 300 includes touch sensors 310 respectively corresponding to the touch sensor regions 120b of the color filter substrate 100a. The driving substrate 300 may be a thin film transistor array substrate, and touch sensors 310 are disposed therein. The position and the size of the touch sensor 310 are not limited, only if each of the touch sensors 310 corresponds to a touch sensing region 120b. That is, the infrared filter layer 140 can be regarded as infrared-light filters, and each of the touch sensors 310 is corresponding to one of the infrared-light filters. The display medium 400 may be a liquid crystal layer. The embodiments of the driving substrate 300 and the display medium 400 shown in FIG. 4 are omitted since are the same as those shown in FIG. 3.

Further, the infrared-light irradiated by a backlight module (not shown) and then transmitting the driving substrate 300, the display medium 400 and the infrared filter layer 140 is shielded when a finger or a stylus touches the outer surface of the substrate 110. Next, the infrared-light is reflected by the substrate 110 and then detected by the touch sensor 310 to confirm the touch position. However, the light with the unreceivable wavelength range for the touch sensor 310 would interfere the signals received by the touch sensor 310, so as to raise the noise and decrease the signal-to-noise ratio (SNR or S/N). Therefore, it is preferred to reduce the light transmittance in visible-light wavelength range of the infrared filter layer 140 to increase the signal-to-noise ratio of the touch sensor 310 while receiving signals.

The infrared filter layer 140 of the embodiments of the present invention has high transmittance in infrared-light wavelength range and has ultra low transmittance in visible-light wavelength range, such that the driving substrate 300 has ultra high signal-to-noise ratio while receiving signals to solve the above-mentioned problems.

In summary, the infrared-light permeable material of the present invention exhibits infrared-light permeable and visible-light shielding properties so as to effectively replace traditional RBM photoresists and to apply to manufacture the infrared-light permeable elements.

It will be apparent to those ordinarily skilled in the art that various modifications and variations may be made to the structure of the present invention without departing from the scope or spirit of the invention. In view of the foregoing, it is intended that the present invention cover modifications and variations thereof provided they fall within the scope of the following claims.

What is claimed is:

1. A color filter substrate for an in-cell optical touch display panel, comprising:
a substrate;
a visible-light shielding structure disposed on the substrate to define a plurality of sub-pixel regions and a plurality of touch sensor regions of the substrate;
a color filter layer covering each of the sub-pixel regions; and
an infrared filter layer covering at least a portion of the touch sensor regions,
wherein the infrared filter layer is made of a single infrared-light permeable material, which has a light transmittance in infrared-light wavelength range greater than a light transmittance in visible-light wavelength range.

2. The color filter substrate of claim 1, wherein the visible-light shielding structure and the infrared filter layer are made of identical material.

3. The color filter substrate of claim 1, wherein the infrared filter layer has a light transmittance less than 5% in visible-light wavelength range of 400-780 nm.

4. The color filter substrate of claim 1, wherein the infrared filter layer has a light transmittance less than 1% in visible-light wavelength range of 400-700 nm.

5. The color filter substrate of claim 1, wherein the infrared filter layer has a light transmittance greater than 70% in infrared-light wavelength range of not smaller than 850 nm.

6. The color filter substrate of claim 1, wherein the infrared filter layer has an optical density value greater than 4.2.

7. The color filter substrate of claim 1, wherein the infrared-light permeable material comprises:
a photo-curable material;
a photo-initiator; and
a plurality of pigments having a content of 40 to 80 wt %, based on the total weight of the infrared-light permeable material.

8. The color filter substrate of claim 7, wherein the pigments are selected from the group consisting of organic pigments, inorganic pigments and a combination thereof.

9. The color filter substrate of claim 8, wherein the organic pigments are selected from the group consisting of red pigments, yellow pigments, green pigments, blue pigments, violet pigments and a combination thereof.

10. The color filter substrate of claim 8, wherein the organic pigments comprises the red pigments having a content of 25 to 40 wt % based on the total weight of the infrared-light permeable material, the green pigments having a content of 5 to 15 wt % based on the total weight of the infrared-light permeable material, and the blue pigments having a content of 10 to 25 wt % based on the total weight of the infrared-light permeable material.

11. The color filter substrate of claim 8, wherein the inorganic pigments are selected from the group consisting of titanium oxide, barium sulfate, calcium carbonate, zinc white, lead sulfate, yellow lead, zinc yellow, red iron oxide (III), cadmium red, ultramarine blue, Prussian blue, chromium oxide green, cobalt green, ocher, titanium black, synthetic iron black, carbon black and a combination thereof.

12. An in-cell optical touch display panel, comprising:
a color filter substrate of claim 1;
a driving substrate parallel to the color filter substrate, wherein the driving substrate comprises a plurality of touch sensors respectively corresponding to the touch sensor regions of the color filter substrate; and
a display medium interposed between the color filter substrate and the driving substrate.

13. An infrared-light permeable material of an infrared filter layer of a color filter substrate of an in-cell optical touch display panel, comprising:
a photo-curable material;
a photo-initiator; and
a plurality of pigments having a content of 40 to 80 wt %, based on the total weight of the infrared-light permeable material,
wherein the infrared-light permeable material has a light transmittance in infrared-light wavelength range greater than a light transmittance in visible-light wavelength range.

14. The infrared-light permeable material of claim 13, wherein the photo-curable material has a content of 10 to 30 wt %, based on the total weight of the infrared-light permeable material.

15. The infrared-light permeable material of claim 13, wherein the pigments are selected from the group consisting of organic pigments, inorganic pigments and a combination thereof.

16. The infrared-light permeable material of claim 15, wherein the organic pigments are selected from the group consisting of red pigments, yellow pigments, green pigments, blue pigments, violet pigments and a combination thereof.

17. The infrared-light permeable material of claim 15, wherein the organic pigments comprises the red pigments having a content of 25 to 40 wt % based on the total weight of the infrared-light permeable material, the green pigments having a content of 5 to 15 wt % based on the total weight of the infrared-light permeable material, and the blue pigments having a content of 10 to 25 wt % based on the total weight of the infrared-light permeable material.

18. The infrared-light permeable material of claim 15, wherein the inorganic pigments are selected from the group consisting of titanium oxide, barium sulfate, calcium carbonate, zinc white, lead sulfate, yellow lead, zinc yellow, red iron oxide (III), cadmium red, ultramarine blue, Prussian blue, chromium oxide green, cobalt green, ocher, titanium black, synthetic iron black, carbon black and a combination thereof.
